(19) United States
(12) Patent Application Publication
(10) Pub. No.: US 2016/0062220 A1
(43) Pub. Date: Mar. 3, 2016

(54) LIGHT SOURCE DEVICE AND PROJECTION-TYPE DISPLAY DEVICE

(71) Applicant: NEC DISPLAY SOLUTIONS, LTD., Tokyo (JP)

(72) Inventor: Atsushi Kato, Tokyo (JP)

(21) Appl. No.: 14/779,318

(22) PCT Filed: May 30, 2013
(86) PCT No.: PCT/JP2013/065002

§ 371 Date: Sep. 22, 2015

(51) Int. Cl. G03B 21/20; G02B 26/00; H04N 9/31; G02B 27/14

(52) U.S. Cl. CPC G03B 21/204; G02B 27/141; G02B 26/008; H04N 9/3111

(57) ABSTRACT

A light source device is provided that can achieve a reduction in size with respect to the direction of irradiation of light to a fluorescent unit as well as a decrease in cost. The light source device (1) is equipped with: light source main body (2), first optical element (3), fluorescent unit (4), and second optical element (5). The first optical element (3) includes first area (13) and second area (14). In response to irradiation of light of a first wavelength that has passed through first area (13), fluorescent unit (4) emits light of a second wavelength toward first area (13). Light of the first wavelength that is reflected at second area (14) is irradiated to second optical element (5). The second optical element (5) emits light of the first wavelength that was irradiated into second optical element (5) in reflection direction (D). The emission position of light of the first wavelength that is emitted from second optical element (5) is located outside virtual space (V1) that extends in the direction opposite to reflection direction (D) from second area (14).

### TECHNICAL FIELD

The present invention relates to a light source device that is provided with a fluorescent unit that produces light of a second wavelength that differs from that of light of a first wavelength in response to irradiation of light of the first wavelength and to a projection-type display device that is equipped with the light source device.

### BACKGROUND ART

Projection-type display devices are known that use display panels to modulate light emitted by a light source device into image light and that then project the image light.

Light source devices that are used as the light source devices of such projection-type display devices include light source devices that are provided with high-luminance discharge lamps and light source devices that are provided with solid-state light sources that emit visible light of a single-wavelength such as LEDs (Light Emitting Diodes), and semiconductor lasers. Solid-state light sources have less impact upon the natural environment than discharge lamps, and for this reason, light source devices that are equipped with solid-state light sources are receiving attention.

Examples of light source devices that are provided with solid-state light sources are disclosed in, for example, Japanese Unexamined Patent Application Publication No. 2010-237443 (hereinbelow referred to as “Patent Document 1”) and International Application Publication Number 2012/127554 (hereinbelow referred to as Patent Document 2”).

In Patent Document 1, a light source device is disclosed that is equipped with a light source main body that emits blue laser light and a fluorescent unit arranged on the path of advance of the blue laser light and that is further provided with a dichroic mirror between the light source main body and the fluorescent unit.

Patent Document 2 discloses a light source device that is equipped with a light source main body that emits blue laser light and a fluorescent unit that is arranged on the path of advance of the blue laser light, that is provided with a dichroic mirror between the light source main body and the fluorescent unit, and that is further provided with a quarter-wave plate between the fluorescent unit and the dichroic mirror.

Neither the light source device that is disclosed in Patent Document 1 nor the light source device disclosed in Patent Document 2 use discharge lamps, and both can emit light of a plurality of colors in the same direction.

### LITERATURE OF THE PRIOR ART

### Patent Documents

Patent Document 1: Japanese Unexamined Patent Application Publication No. 2010-237443

Patent Document 2: International Application Publication No. 2012/127554

### SUMMARY OF THE INVENTION

### Problem to be Solved by the Invention

Nevertheless, in the light source device disclosed in Patent Document 1, the fluorescent unit transmits a portion of the light that is emitted from the light source main body, and as a result, a reflecting mirror must be provided on the path of advance of the light that follows passage through the fluorescent unit. As a result, this light source device increases in size with respect to the direction of irradiation of the light to the fluorescent unit.

In addition, in the light source device disclosed in Patent Document 2, the dichroic mirror must have the characteristic of separating S-polarized light and P-polarized light of a specific wavelength (for example, in the vicinity of 450 nm that is the blue wavelength band) that passes through the fluorescent unit. A dichroic mirror having this characteristic is exceedingly difficult to fabricate, and the resulting dichroic mirror is quite costly, thereby leading to an increase of the cost of the light source device.

One example of the object of the present invention is to provide a light source device that can achieve a reduction of size with regard to the direction of irradiation of light to the fluorescent unit, and moreover, that is less expensive.

### Means for Solving the Problem

According to one aspect of the present invention, a light source main body, a first optical element, a fluorescent unit, and a second optical element are provided. The light source main body emits light of a first wavelength. The first optical element includes a first area that transmits light of the first wavelength and reflects light of a second wavelength that differs from the first wavelength and a second area that reflects light of the first wavelength. The first optical element is further provided such that light of the first wavelength that is emitted from the light source main body successively irradiates the first and second areas. The fluorescent unit emits light of the second wavelength toward the first area in response to the irradiation of light of the first wavelength that is transmitted through the first area. Light of the first wavelength that is reflected by the second area is irradiated into the second optical element. The second optical element emits light of the first wavelength that was irradiated into the second optical element in the reflection direction towards which the light of the second wavelength that was emitted from the fluorescent unit was reflected by the first area. The emission position of light of the first wavelength that is emitted from the second optical element is located outside the virtual space that extends from the second area in the direction opposite to the reflection direction.

### Effect of the Invention

The light source device of the present invention is smaller in size with respect to the direction of irradiation of light to the fluorescent unit, and moreover, is less expensive.

### BRIEF DESCRIPTION OF THE DRAWINGS

FIG. 1 is a schematic top view of the light source device according to the first exemplary embodiment of the present invention.

FIG. 2 is a front view of the first optical element shown in FIG. 1.

FIG. 3 is a graph showing the characteristics of a dielectric multilayer film that is vapor-deposited in the first area shown in FIG. 2.

FIG. 4 is a perspective view of the second optical element shown in FIG. 1.

FIG. 5 is a front view of the fluorescent unit shown in FIG. 1.

FIG. 6 is a view for describing the path of advance of light in the light source device.

FIG. 7 is a view for describing the path of advance of light in the light source device.

FIG. 8 is a front view of the first optical element according to another example.

FIG. 9 is a view for describing the path of advance of light in the light source device that is provided with the first optical element shown in FIG. 8.

FIG. 10 is a schematic top view of the light source device according to the second exemplary embodiment of the present invention.

FIG. 11 is a front view of the diffusion unit shown in FIG. 10.

FIG. 12 is a schematic view of a projection-type display device that is equipped with the light source device shown in FIG. 10.

FIG. 13 is a schematic top view of the light source device according to the third exemplary embodiment of the present invention.

FIG. 14 is a front view of the fluorescent unit shown in FIG. 13.

FIG. 15 is a front view of the separation unit shown in FIG. 13.

FIG. 16 is a schematic view of a projection-type display device that is equipped with the light source device according to the fourth exemplary embodiment of the present invention.

FIG. 17 is a view for describing the lens system that converts light emitted by a plurality of light source main bodies into a plurality of parallel light beams of small luminous flux diameter.

### CARRYING OUT THE INVENTION

Exemplary embodiments of the present invention are next described with reference to the accompanying drawings.

### First Exemplary Embodiment

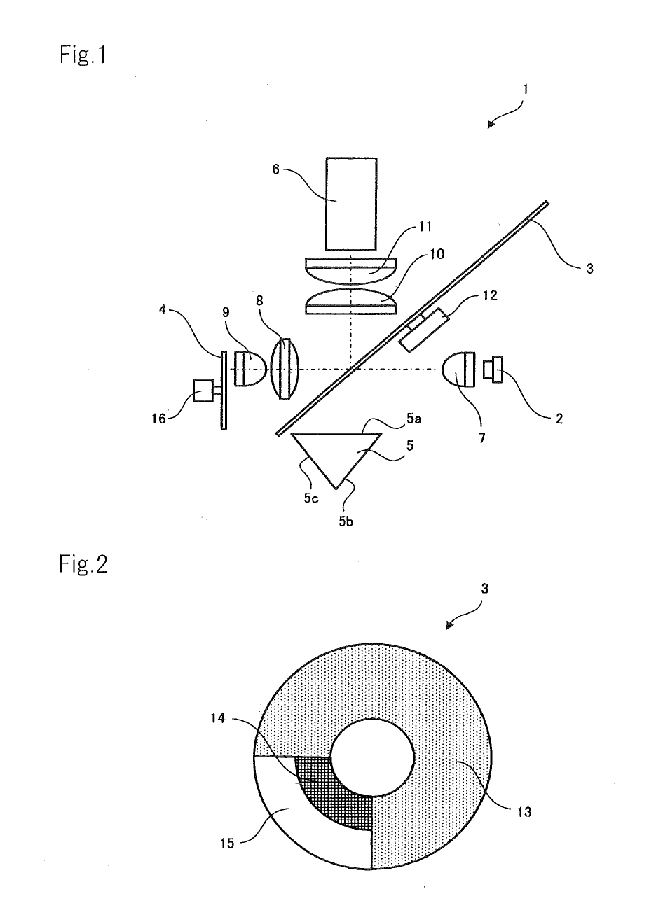

The light source device according to the first exemplary embodiment is first described using FIGS. 1 to 5. FIG. 1 is a schematic top view of the light source device according to the present exemplary embodiment. As shown in FIG. 1, light source device 1 according to the present exemplary embodiment is equipped with light source main body 2, first optical element 3, fluorescent unit 4, second optical element 5, and rod integrator 6.

Collimator lens 7 is arranged between light source main body 2 and first optical element 3, and lenses 8 and 9 are arranged between first optical element 3 and fluorescent unit 4. Lenses 10 and 11 are arranged between first optical element 3 and rod integrator 6.

Light source main body 2 emits light of a first wavelength. The light of the first wavelength is laser light having a wavelength of, for example, 450 nm Of course, light of the first wavelength is not limited to laser light having a wavelength of 450 nm and may be laser light having a wavelength of, for example, 410 nm or 460 nm. A blue semiconductor laser light source can emit laser light of this type and can be readily acquired.

As light source main body 2, a blue semiconductor laser light source emits light that spreads at a prescribed angle. Because collimator lens 7 is provided on the path of advance of the light that is emitted from light source main body 2, the spread of the light emitted from light source main body 2 is limited and a parallel pencil of rays is formed.

In FIG. 1, the lens system that converts light into parallel pencil of rays is made up of a single planoconvex lens, but a plurality of lenses may also be used to make up the lens system.

First optical element 3 includes a glass plate having a round shape. Motor 12 is linked to, the surface of incidence of light of first optical element 3, that is emitted from light source main body 2. The operation of motor 12 causes first optical element 3 to rotate around the optical element axis (axis of rotation) that intersects the plane of incidence.

FIG. 2 is a front view of first optical element 3. As shown in FIG. 2, first optical element 3 includes three areas 13, 14, and 15.

First area 13 transmits light of the first wavelength (for example, blue light) and reflects light of the second wavelength (for example, green or red light) that differs from the light of the first wavelength. For example, first area 13 is formed on-a predetermined area of a transparent glass plate by the vapor deposition of a dielectric multi-layered film that reflects green or red light and transmits blue light.

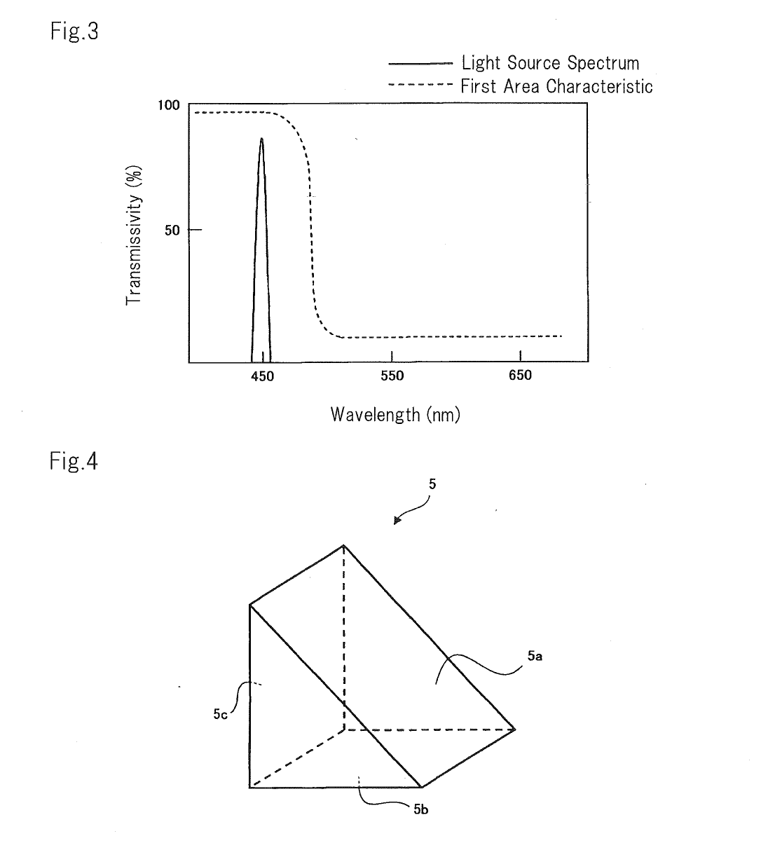

FIG. 3 is a graph showing the characteristics of a dielectric multilayered film that has been vapor-deposited in first area 13. The horizontal axis shows the wavelength and the vertical axis shows the transmissivity. This type of dielectric multilayered film is typically used in liquid crystal projectors and can be readily acquired.

Referring again to FIG. 2, second area 14 reflects light. For example, second area 14 is formed by vapor deposition of a metal such as aluminum, chrome, or silver on an area of the glass plate that differs from the area on which the dielectric multilayered film was vapor-deposited. Second area 14 may be formed so as to reflect light of at least the first wavelength.

First and second areas 13 and 14 are aligned with respect to the direction of rotation of first optical element 3. Accordingly, the rotation of first optical element 3 causes light of the first wavelength that is emitted from light source main body 2 to successively irradiate first and second areas 13 and 14.

Third area 15 transmits light. For example, the third area is the area of the transparent glass plate in which nothing has been vapor-deposited. A coating for preventing the reflection of light is preferably applied to the third area. Third area 15 should be formed so as to transmit light of the first wavelength.

In the present exemplary embodiment, second and third areas 14 and 15 are aligned in a direction that crosses the axis (axis of rotation) of the optical element, i.e., a radial direction. In the example shown in FIG. 2, third area 15 is positioned on the side opposite to the side of the optical element axis (the outer circumference side) of second area 14, but third area 15 may also be positioned between second area 14 and the optical element axis (the inner circumference side).

Second optical element 5 (refer to FIG. 1) is, for example, a triangular prism realized by polishing and processing optical glass or optical resin. FIG. 4 is a perspective view showing an example of second optical element 5. Light that is irradiated from first surface 5a of second optical element 5 is reflected at second surface 5b and advances to third surface 5c. The light is then reflected at third surface 5c and emitted from first surface 5a.

Second optical element 5 is not limited to a triangular prism and may also be an element composed of two reflecting mirrors.

Again referring to FIG. 1, lenses 8 and 9 form a lens system that collects light of the first wavelength that is emitted from light source main body 2 in fluorescent unit 4. Optical glass or optical resin can be used as the material of lenses 8 and 9.

The lens system that gathers light in fluorescent unit 4 may be constructed from one or three or more lenses. This lens system may be formed by using a lens having a surface that is not spherical, such as an aspheric surface or a free-form surface.

Fluorescent unit 4 contains a glass plate that has a circular shape. Motor 16 is linked to, the surface of the side that is opposite to the surface of incidence into which is irradiated light that has been transmitted through the first area of fluorescent unit 4. The operation of motor 12 causes fluorescent unit 4 to rotate around the fluorescent unit axis that intersects the surface of incidence.

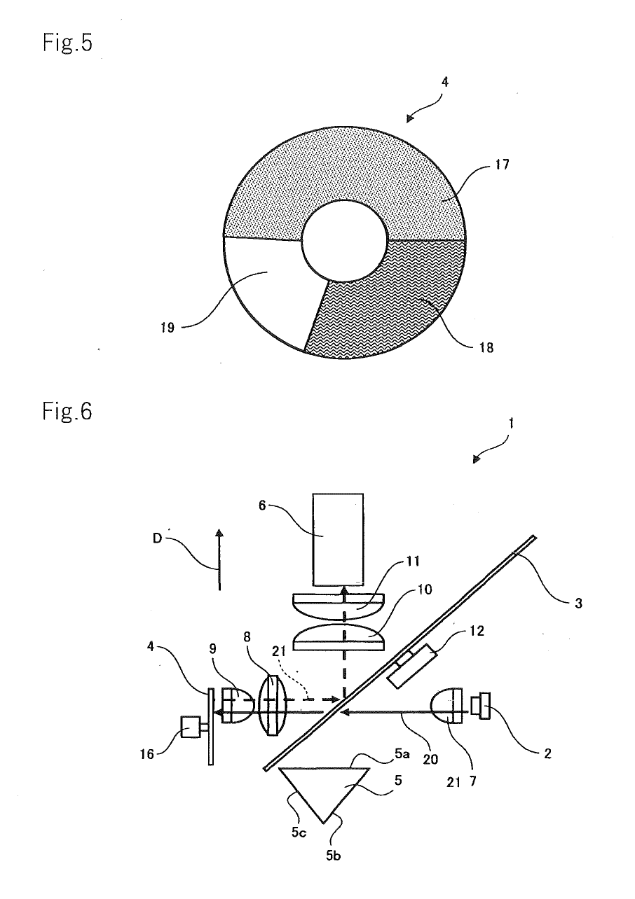

FIG. 5 is a front view of fluorescent unit 4. As shown in FIG. 5, fluorescent unit 4 contains fluorescent areas 17 and 18 and non-fluorescent area 19.

Fluorescent areas 17 and 18 emit light of a second wavelength (for example, green or red light) that differs from the light of the first wavelength in response to the irradiation of light of the first wavelength (for example, blue light). For example, fluorescent areas 17 and 18 are formed by adhering, to a prescribed area of a glass plate, a phosphor that emits fluorescent light in response to the irradiation of blue laser light. The ground coat of the surface to which the phosphor is adhered is preferably a reflecting surface.

In the present exemplary embodiment, fluorescent area 17 is formed by adhering to the glass plate a phosphor that emits green fluorescent light in response to the irradiation of blue laser light. Fluorescent area 18 is formed by adhering to the glass plate a phosphor that emits red fluorescent light in response to the irradiation of blue laser light.

Non-fluorescent area 19 is an area in which a phosphor is not adhered. Accordingly, non-fluorescent area 19 either transmits light of the first wavelength that is irradiated or reflects light of the first wavelength that is irradiated without emitting fluorescent light despite the irradiation of light of the first wavelength in non-fluorescent area 19.

Non-fluorescent area 19 need not be provided, and fluorescent unit 4 may be constituted by only fluorescent areas 17 and 18.

Fluorescent areas 17 and 18 are aligned with respect to the rotating direction of fluorescent unit 4. Accordingly, the rotation of fluorescent unit 4 causes successive irradiation of fluorescent areas 17 and 18 by light of the first wavelength that has been transmitted through first optical element 3.

Again referring to FIG. 1, lenses 8 and 9 also function as a lens system that converts light emitted by fluorescent unit 4 to parallel light beams.

Lenses 10 and 11 form a lens system for collecting the light directed toward rod integrator 6 at the surface of incidence of rod integrator 6. Optical glass or optical resin can be used as the material of lenses 10 and 11.

The lens system that collects the light in rod integrator 6 may be constituted from one or three or more lenses. In addition, the lens system may also be formed using lenses having a surface other than a spherical surface, such as an aspheric surface or a free-form surface.

Rod integrator 6 is a component having a prism shape. Optical glass or optical resin can be used as the material of rod integrator 6.

Although not shown in FIG. 1, a component referred to as a light tunnel in which four reflecting mirrors are combined may also be used in place of rod integrator 6.

Still further, an integrator composed of two fly-eye lenses may also be used in place of rod integrator 6. In this case, the lens system that collects light at the integrator is configured by using at least one lens having a shape that differs from the shapes of lenses 10 and 11.

The operation of light source device 1 according to the present exemplary embodiment is next described.

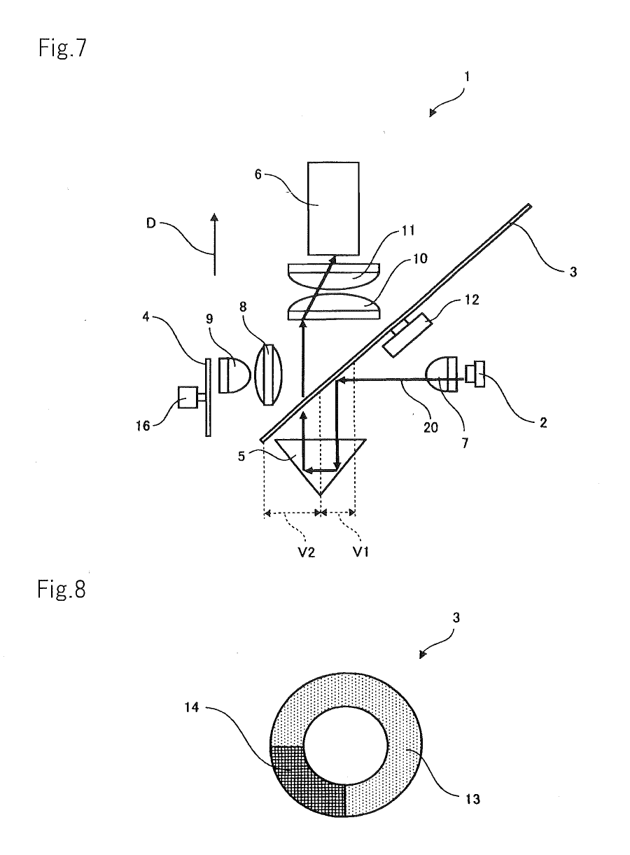

Using FIGS. 6 and 7, the path of advance of light in light source device 1 is described. FIGS. 6 and 7 are views for describing the path of advance of light in light source device 1.

As shown in FIGS. 6 and 7, light of the first wavelength 20 that is emitted from light source main body 2 passes through collimator lens 7 and reaches first optical element 3. When light of the first wavelength 20 reaches first optical element 3, the path of advance of light in light source device 1 differs depending on whether first area 13 (refer to FIG. 2) is positioned on the path of first wavelength light 20 or whether second area 14 (see FIG. 2) is positioned on the path of first wavelength light 20.

A case in which first area 13 (see FIG. 2) is positioned on the path of first wavelength light 20 is first described using FIGS. 2, 5, and 6. Because first area 13 is positioned on the path of first wavelength light 20, first wavelength light 20 passes though first optical element 3.

First wavelength light (blue laser light) 20 that has passed through first optical element 3 is irradiated into fluorescent unit 4 via lenses 8 and 9. Fluorescent unit 4 rotates around the fluorescent unit axis and first wavelength light 20 therefore irradiates fluorescent area 17 or fluorescent area 18. Fluorescent unit 4 then emits second wavelength light 21.

When fluorescent area 17 is positioned on the path of first wavelength light 20, fluorescent unit 4 emits green fluorescent light. When fluorescent area 18 is positioned on the path of first wavelength light 20, fluorescent unit 4 emits red fluorescent light.

Second wavelength light 21 that is emitted by fluorescent-unit 4 becomes light that advances substantially parallel through the use of lenses 9 and 8 and proceeds toward first area 13 of first optical element 3. When second wavelength light 21 reaches first optical element 3, second wavelength light 21 is reflected at first area 13.

Second wavelength light 21 that is reflected at first area 13 is irradiated into rod integrator 6 by way of lenses 10 and 11. Second wavelength light 21 is then repeatedly reflected inside rod integrator 6 to become a uniform light beam, emitted from the rod integrator, and irradiated into an optical component such as a display panel (not shown).

Next, using FIGS. 2, 5, and 7, a case is described in which second area 14 is positioned on the path of first wavelength light 20 when first wavelength light 20 emitted from light source main body 2 reaches first optical element 3.

Second area 14 is positioned on the path of first wavelength light 20 that is emitted from light source main body 2 and first wavelength light 20 is therefore reflected at second area 14. First wavelength light 20 that is reflected at second area 14 is irradiated into second optical element 5.

First wavelength light 20 that is irradiated into second optical element 5 is reflected two times inside second optical element 5 and then emitted from second optical element 5. At this time, second optical element 5 emits first wavelength light 20 in reflection direction D in which second wavelength light 21 that was emitted from fluorescent unit 4 (see FIG. 6) was reflected by first area 13.

The position of emission of first wavelength light 20 that is emitted from second optical element 5 is located outside virtual space V1 that extends in the direction opposite reflection direction D from second area 14. Accordingly, first wavelength light 20 that is emitted from second optical element 5 is not directed toward second area 14.

In the present exemplary embodiment, the position of emission of first wavelength light 20 that is emitted from second optical element 5 is located inside virtual space V2 that extends in the direction opposite to the reflection direction D from third area 14. Accordingly, first wavelength light 20 that is emitted from second optical element 5 is directed toward third area 15.

First wavelength light 20 that reaches third area 15 is transmitted through third area 15 and irradiated into rod integrator 6 by way of lenses 10 and 11. The behavior of first wavelength light 20 after irradiation into rod integrator 6 is identical to that of second wavelength light 21 (see FIG. 6) and redundant explanation is therefore omitted.

As described above, light source device 1 according to the present exemplary embodiment is able to use light of a first wavelength emitted by light source main body 2 to emit light of first and second wavelengths in the same direction. Controlling the modulation of the display panel to synchronize with the color of light emitted by light source device 1 enables projection of a color image.

In light source device 1 according to the present exemplary embodiment, first wavelength light emitted by light source main body 2 does not pass through fluorescent unit 4. Accordingly, light source device 1 does not require a reflecting mirror on the side of fluorescent unit 4 opposite to the side of irradiation of light. As a result, the size of light source device 1 can be reduced with respect to the direction of irradiation of light into fluorescent unit 4.

In addition, light source device 1 does not require a dichroic mirror for separating the S-polarized light component and P-polarized light component of the first wavelength light. Accordingly, light source device 1 can be fabricated from less expensive parts and the cost of the light source device can be limited.

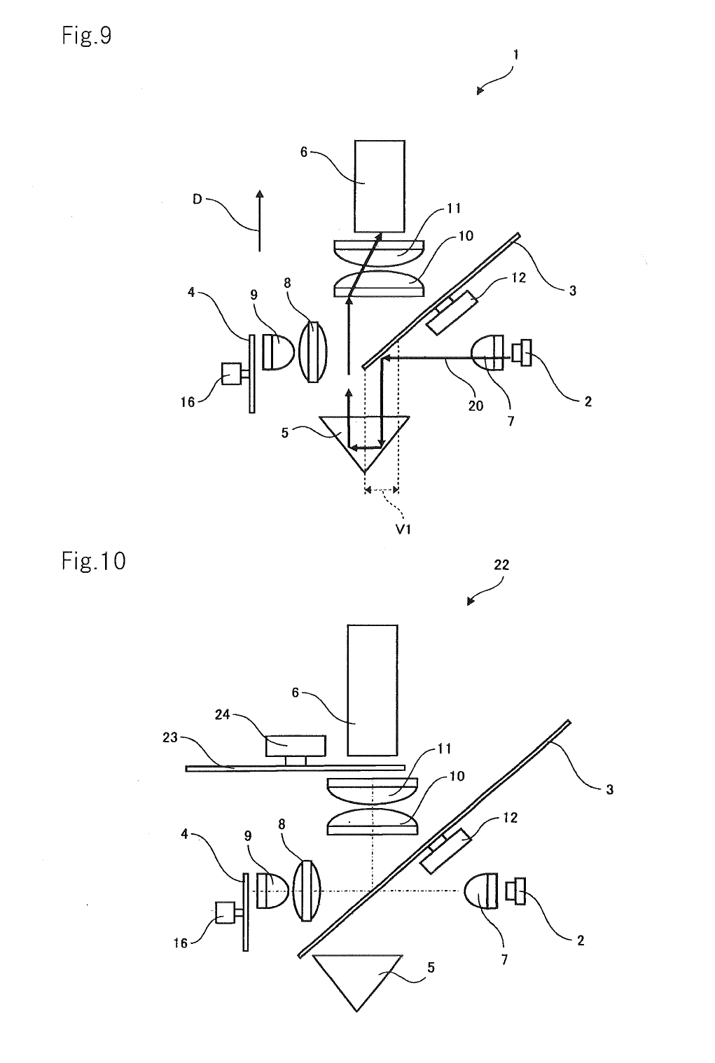

In the present exemplary embodiment, third area 15 is provided in first optical element 3, but third area 15 need not be provided in first optical element 3. For example, first optical element 3 may be constructed as shown in FIG. 8, and no problem arises as long as second area 14 is not positioned on the path of advance of light that is emitted from second optical element 5, as shown in FIG. 9.

### Second Exemplary Embodiment

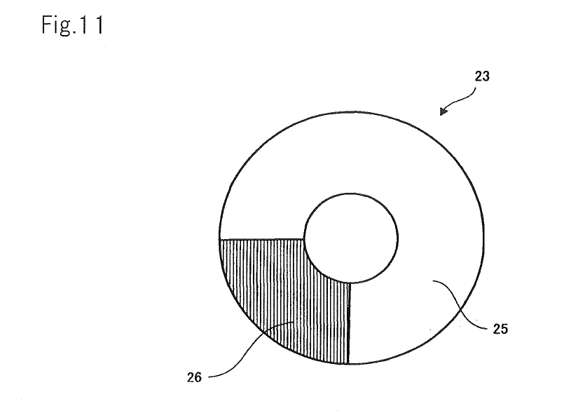

The second exemplary embodiment of the present invention is next described using FIGS. 10 and 11. Constituent elements that are identical to elements of the first exemplary embodiment are given the same reference numbers and redundant explanation is omitted.

FIG. 8 is a schematic plan view of the light source device according to the present exemplary embodiment. As shown in FIG. 1, light source device 22 according to the present exemplary embodiment is equipped with diffusion unit 23 that is arranged between rod integrator 6 and lens 11.

Diffusion unit 23 includes a transparent plate having a round shape. The transparent plate is, for example, a glass plate. Motor 24 is linked to the surface of diffusion unit 23 on the side opposite to the surface of incidence to which light emitted from lens 11 is irradiated. The operation of motor 24 causes diffusion unit 23 to rotate around the diffusion unit axis that intersects the surface of incidence.

FIG. 11 is a front view of diffusion unit 23. As shown in FIG. 11, diffusion unit 23 contains transmission area 25 and diffusion area 26. Transmission area 25 passes irradiated light without diffusing the light. Diffusion area 26 passes irradiated light while diffusing the light.

Transmission area 25 and diffusion area 26 are aligned in the rotating direction of diffusion unit 23. Accordingly, light emitted from lens 11 successively irradiates transmission area 25 and diffusion area 26 due to the rotation of diffusion unit 23.

In addition, diffusion unit 23 rotates corresponding to the rotation of first optical element 3. The operation of diffusion unit 23 is explained more concretely using FIGS. 2, 10 and 11.

A case is first considered in which first area 13 of first optical element 3 is positioned on the path of light that is emitted from light source main body 2. In this case, light of the first wavelength that is emitted from light source main body 2 passes through first area 13 and is irradiated upon fluorescent unit 4.

Fluorescent unit 4 emits light of the second wavelength toward first area 13 in response to the irradiation of light of the first wavelength. The light of second wavelength advances by way of first area 13 of first optical element 3 toward rod integrator 6. At this time, transmission area 25 is positioned on the path of light that is irradiated into rod integrator 6. Accordingly, light of the second wavelength passes through transmission area 25 and is irradiated into rod integrator 6.

A case is next considered in which-second area 14 of first optical element 3 is positioned on the path of light emitted from light source main body 2. In this case, first wavelength light that is emitted from light source main body 2 is irradiated into second optical element 5 by way of second area 14.

Second optical element 5 emits first wavelength light in the direction of third area 15 of first optical element 3. First wavelength light passes through third area 15 and is directed toward rod integrator 6. At this time, diffusion area 26 is positioned on the path of the light that irradiates rod integrator 6. Accordingly, the first wavelength light is diffused when passing through diffusion area 26 and is irradiated into rod integrator 6.

Using light that is emitted by light source device 22 according to the present exemplary embodiment to project an image improves the quality of the projected image.

For example, in light source device 1 according to the first exemplary embodiment (see FIG. 1), light of the first wavelength that is emitted from rod integrator 6 is laser light and not light for which the wavelength has been converted. Using laser light to project an image gives rise to a phenomenon known as speckle noise that is caused by the coherence of the laser light, and the quality of the projected image may therefore be reduced.

According to the present exemplary embodiment, diffusion area 26 diffuses the laser light and thus greatly mitigates the speckle noise of the first wavelength light. As a result, the image is projected using light that contains virtually no speckle noise, and the quality of the projected image is improved.

In particular, because diffusion unit 23 is rotating, the portion that is irradiated by first wavelength light changes with the passage of time in diffusion area 26. Accordingly, speckle is greatly reduced.

Diffusion unit 23 may also be positioned on the path of light that is emitted from rod integrator 6.

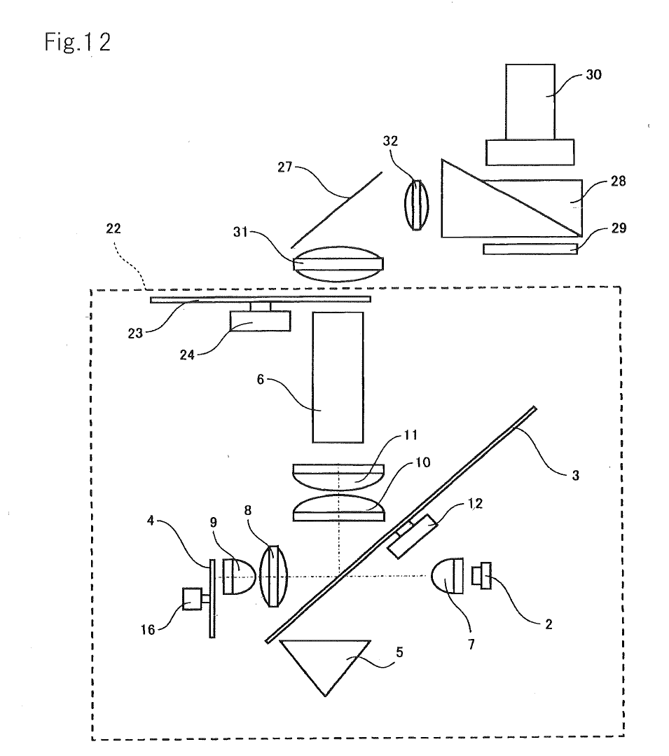

FIG. 12 is a schematic view of a projection-type display device that is equipped with light source device 22. As shown in FIG. 12, the projection-type display device is provided with reflecting mirror 27, TIR (Total Internal Reflector) prism 28, display panel 29, projection lens 30, lens 31, and lens 32.

Reflecting mirror 27 is provided on the path of light that is emitted by rod integrator 6 and guides the light to TIR prism 28. Reflecting mirror 27 merely alters the direction of the travel of light, and consequently, reflecting mirror 27 need not be provided in a projection-type display device when the direction of the travel of light does not need to be changed.

TIR prism 28 both emits light from reflecting mirror 27 toward display panel 29 and emits light from display panel 29 toward projection lens 30.

A DMD (Digital Micromirror Device) can be used as display panel 29. When a DMD is used, light must be irradiated into the DMD at a specific angle to the DMD. The use of TIR prism 28 enables the irradiation of light at the specific angle. The use of TIR prism 28 is extremely typical in a projection-type display device that is provided with a DMD.

Lens 31 is arranged between rod integrator 6 and reflecting mirror 27, and lens 32 is arranged between reflecting mirror 27 and TIR prism 28. Lenses 31 and 32 form the image of the emission surface of rod integrator 6 on a display panel. The number and shape of lenses 31 and 32 are modified as appropriate according to, for example, the area of the emission surface of rod integrator 6.

The relation between the colors (green, red, and blue) of light that is irradiated upon display panel 29 and each area of first optical element 3, fluorescent unit 4, and diffusion unit 23 is here described using Table 1.

Green, red, and blue light is repeatedly irradiated upon display panel 29. Table 1 shows each area of first optical element 3, fluorescent unit 4, and diffusion unit 23 that are positioned on the path of light when light of each color is irradiated upon display panel 29.

TABLE 1

| Display | First Optical | | |
|---|---|---|---|
| Panel 29 | Element 3 | Fluorescent Unit 4 | Diffusion Unit 23 |
| Green | First Area 13 | Fluorescent Area 17 | Transmission Area 25 |
| Red | First Area 13 | Fluorescent Area 18 | Transmission Area 25 |
| Blue | Second | Non-Fluorescent | Diffusion Area 26 |
| | Area 14 | Area 19 | |
| Green | First Area 13 | Fluorescent Area 17 | Transmission Area 25 |
| Red | First Area 13 | Fluorescent Area 18 | Transmission Area 25 |
| Blue | Second | Non-Fluorescent | Diffusion Area 26 |
| | Area 14 | Area 19 | |
| . . . | | | |

A case is first considered in which green light is irradiated upon display panel 29.

First optical element 3 is controlled such that first area 13 of first optical element 3 is positioned on the path of light of the first wavelength that is emitted from light source main body 2. Fluorescent unit 4 is controlled such that fluorescent area 17 of fluorescent unit 4 is positioned on the path of light that has passed through first optical element 3. Diffusion unit 23 is controlled such that transmission area 25 of diffusion unit 23 is positioned on the path of light that is irradiated into rod integrator 6 or light that is emitted from rod integrator 6.

A case is next considered in which red light is irradiated upon display panel 29.

First optical element 3 is controlled such that first area 13 of first optical element 3 is positioned on the path of light of the first wavelength that is emitted from light source main body 2. In addition, fluorescent unit 4 is controlled such that fluorescent area 18 of fluorescent unit 4 is positioned on the path of light that has passed through first optical element 3. Diffusion unit 23 is then controlled such that transmission area 25 of diffusion unit 23 is positioned on the path of light that is irradiated into rod integrator 6 or light that is emitted from rod integrator 6.

A case is next considered in which blue light is irradiated upon display panel 29.

First optical element 3 is controlled such that second area 14 of first optical element 3 is positioned on the path of light of the first wavelength that is emitted from light source main body 2. In addition, fluorescent unit 4 is controlled such that non-fluorescent area 19 of fluorescent unit 4 is positioned on the path of light that has passed through first optical element 3. Diffusion unit 23 is then controlled such that diffusion area 26 of diffusion unit 23 is positioned on the path of light that is irradiated into rod integrator 6 or light that is emitted from rod integrator 6.

First optical element 3, fluorescent unit 4, and diffusion unit 23 are thus mutually controlled. This control is possible through the provision of, for example, position sensors in first optical element 3, fluorescent unit 4, and diffusion unit 23. This control is realized by applying the technology used in known projection-type display devices that use color wheels.

### Third Exemplary Embodiment

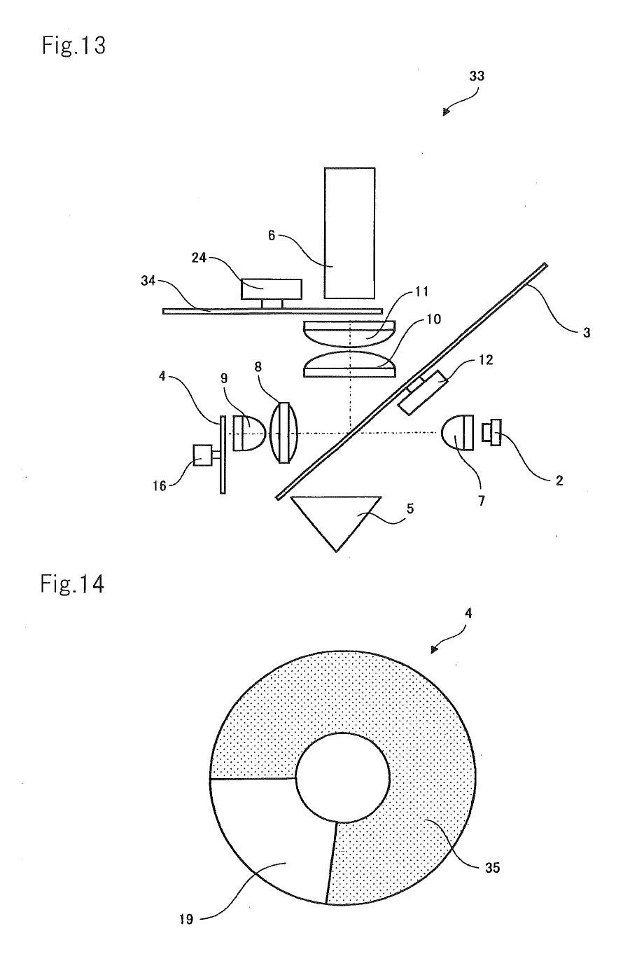

The light source device according to the third exemplary embodiment of the present invention is next described using FIGS. 13 to 15. Constituent elements that are identical to elements of the first and second exemplary embodiments are given the same reference numbers and redundant explanation is omitted.

FIG. 13 is a schematic top view of the light source device according to the present exemplary embodiment. As shown in FIG. 13, light source device 33 according to the present exemplary embodiment is provided with separation unit 34 in place of diffusion unit 23 shown in FIG. 10.

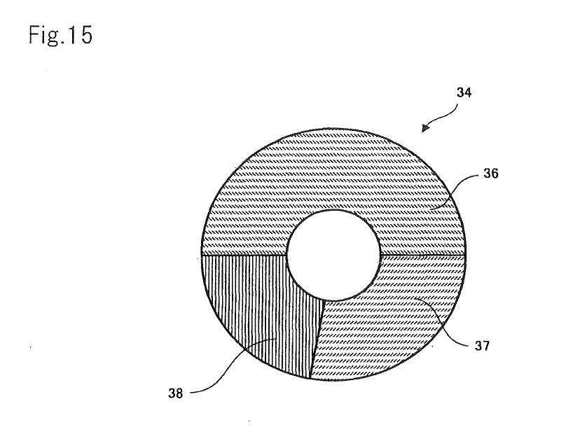

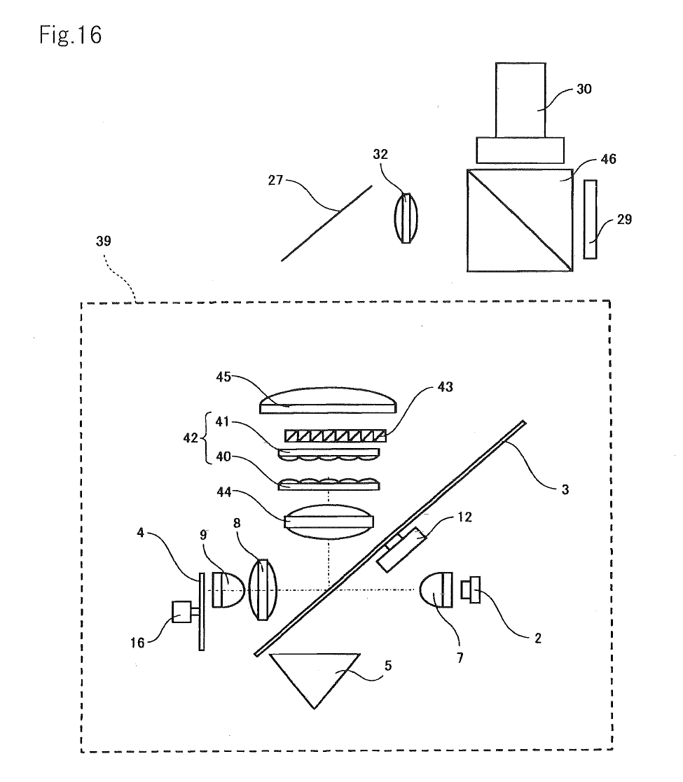

FIG. 14 is a front view of fluorescent unit 4 that is included in the present exemplary embodiment. As shown in FIG. 14, in the present exemplary embodiment, fluorescent unit 4 includes non-fluorescent area 19 and fluorescent area 35 that emits light of the yellow wavelength band in response to the irradiation of light of the first wavelength. Fluorescent area 35 is formed by adhering, in a prescribed area, a phosphor that emits light of the yellow wavelength band in response to irradiation of light of the first wavelength.

FIG. 15 is a front view of separation unit 34 that is contained in the present exemplary embodiment. As shown in FIG. 15, separation unit 34 contains green light transmission area 36, red light transmission area 37, and diffusion area 38 corresponding to fluorescent unit 4 (see FIG. 14) that contains fluorescent area 35. Green light transmission area 36 has the characteristic of transmitting, from light of the yellow wavelength band, only light of the green wavelength band, and red light transmission area 37 has the characteristic of transmitting, from the light of the yellow wavelength band, only light of the red wavelength band.

Green light transmission area 36 and red light transmission area 37 are formed by vapor deposition of dielectric multilayered films on a glass plate under prescribed conditions. The formation of the dielectric multilayered films and the vapor deposition of the dielectric multilayered films on a glass plate are known technology used when forming a dichroic mirror.

The control of the rotation of first optical element 3, fluorescent unit 4, and separation unit 34 is next described using FIGS. 2, 13, 14, and 15.

A case is first considered in which green light is irradiated upon display panel 29 (see FIG. 12).

First optical element 3 is controlled such that first area 13 of first optical element 3 is positioned on the path of light of the first wavelength that is emitted from light source main body 2. Second optical element 5 is controlled such that fluorescent area 35 of fluorescent unit 4 is positioned on the path of light that has passed through first optical element 3. Separation unit 34 is then controlled such that green light transmission area 36 of separation unit 34 is positioned on the path of light that is irradiated into rod integrator 6 or light that is emitted from rod integrator 6.

A case is next considered in which red light is irradiated upon display panel 29 (see FIG. 12).

First optical element 3 is controlled such that first area 13 of first optical element 3 is positioned on the path of light of the first wavelength that is emitted from light source main body 2. Fluorescent unit 4 is controlled such that fluorescent area 35 of fluorescent unit 4 is positioned on the path of light that has passed through first optical element 3. Separation unit 34 is then controlled such that red light transmission area 37 of separation unit 34 is positioned on the path of light that is irradiated into rod integrator 6 or light that is emitted from rod integrator 6.

A case is next considered in which blue light is irradiated into display panel 29 (see FIG. 12).

First optical element 3 is controlled such that second area 14 of first optical element 3 is positioned on the path of light of the first wavelength that is emitted from light source main body 2. Fluorescent unit 4 is controlled such that non-fluorescent area 19 of fluorescent unit 4 is positioned on the path of light that has passed through first optical element 3. Separation unit 34 is then controlled such that diffusion area 38 of separation unit 34 is positioned on the path of light that is irradiated into rod integrator 6 or light that is emitted from rod integrator 6.

By this control of first optical element 3, fluorescent unit 4, and diffusion unit 23, green, red, and blue light is irradiated in display panel 29. This control is enabled by the provision of position sensors in first optical element 3, fluorescent unit 4, and diffusion unit 23. This control is realized by applying the technology that is used in known projection-type display devices that employ color wheels.

### Fourth Exemplary Embodiment

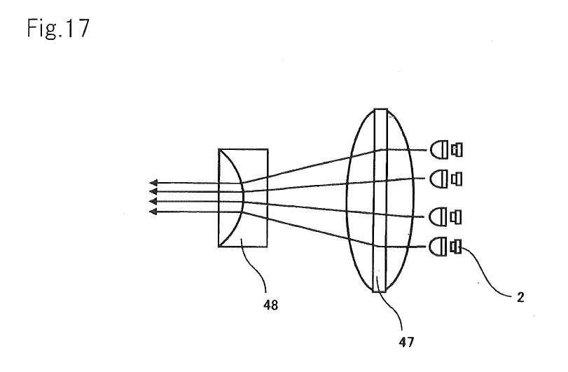

The fourth exemplary embodiment of the present invention is next described using FIG. 16. FIG. 16 is a schematic view of a projection-type display device that is provided with the light source device according to the present exemplary embodiment.

As shown in FIG. 16, light source device 39 according to the present exemplary embodiment is equipped with integrator 42 composed of fly-eye lenses 40 and 41 in place of rod integrator 6 (see for example FIG. 1) that is included in the first to third exemplary embodiments. Light source device 39 is further provided with multi-PBS (Polarizing Beam Splitter) 43, lens 44, and lens 45.

In the projection-type display device provided with light source device 39, LCoS (Liquid-Crystal-on-Silicon) can be used as display panel 29. A DMD may also be used as display panel 29.

Light of the second wavelength that is emitted from fluorescent unit 4 and light of the first wavelength that is emitted by second optical element 5 pass by way of lens 44, fly-eye lenses 40 and 41, multi-PBS 43, and lens 45 to reach reflecting mirror 27. The light reflected by reflecting mirror 27 reaches polarizing beam splitter 46 via lens 32.

Polarizing beam splitter 46 guides light to display panel 29 and guides light that has been modulated to an image using display panel 29 to projection lens 30. Projection lens 30 projects the light to enlarge and display an image.

In the first to fourth exemplary embodiments, only one light source main body 2 was provided. In the present invention, a plurality of light source main bodies 2 may be aligned as shown in FIG. 17. In this case, the light emitted by each of light source main bodies 2 is preferably used as a plurality of parallel light beams of luminous flux of small diameter through the use of a lens system made up of lens 47 and lens 48.

A phosphor emits more fluorescent light in response to an increase of the intensity of the excitation light that excites the phosphor. Accordingly, increasing the number of light source main bodies 2 to raise the intensity of the light of the first wavelength can realize a light source device and projection-type display device having greater luminance.

### EXPLANATION OF REFERENCE NUMBERS

1 light source device
2 light source main body
3 first optical element
4 fluorescent unit
5 second optical element
6 rod integrator
7 collimator lens
8 lens
9 lens
10 lens
11 lens
12 motor
13 first area
14 second area
15 third area
16 motor
17 fluorescent area
18 fluorescent area
19 non-fluorescent area
20 first wavelength light
21 second wavelength light
22 light source device
23 diffusion unit
24 motor
25 transmission area
26 diffusion area
27 reflecting mirror
28 TIR prism
29 display panel
30 projection lens
31 lens
32 lens
33 light source device
34 separation unit
35 fluorescent area
36 green light transmission area
37 red light transmission area
38 diffusion area
39 light source device
40 fly-eye lens
41 fly-eye lens
42 integrator
43 multi-PBS
44 lens
45 lens
46 polarizing beam splitter
47 lens
48 lens

1. A light source device comprising:
a light source main body that emits light of a first wavelength;
a first optical element that includes a first area that transmits light of said first wavelength and reflects light of a second wavelength that differs from said first wavelength and a second area that reflects light of said first wavelength, said first and second areas being provided such that light of said first wavelength that is emitted from said light source main body successively irradiates said first and second areas;
a fluorescent unit that emits light of said second wavelength toward said first area in response to irradiation of light of said first wavelength that is transmitted through said first area; and
a second optical element into which is irradiated light of said first wavelength that was reflected at said second area;
wherein:
said second optical element emits light of said first wavelength, which was irradiated into said second optical element, in the direction of reflection by said first area of light of said second wavelength that was emitted from said fluorescent unit; and
the emission position of light of said first wavelength that is emitted from said second optical element is located outside a virtual space that extends in the direction opposite to said direction of reflection from said second area.

2. The light source device as set forth in claim 1, wherein:
said first optical element further includes a third area that transmits light of said first wavelength; and
light of the first wavelength that is emitted from said second optical element passes through said third area.

3. The light source device as set forth in claim 2, wherein:
said first optical element is rotatably provided; and
said second and third areas are aligned in a direction that intersects the axis of rotation of said first optical element.

4. The light source device as set forth in claim 1, wherein said second optical element comprises a triangular prism.

5. The light source device as set forth in claim 1, wherein:
said fluorescent unit is provided so as to be rotatable around a fluorescent unit axis that intersects the surface of incidence of light of said first wavelength that has passed through said first area; and
said fluorescent unit includes at least two fluorescent areas that emit light of mutually different wavelengths in response to irradiation of light of said first wavelength, said at least two fluorescent areas being aligned with the direction of rotation of said fluorescent unit.

6. The light source device as set forth in claim 1, further comprising a diffusion unit that diffuses light of said first wavelength that was emitted by said second optical element.

7. The light source device as set forth in claim 1, wherein:
light of said second wavelength comprises light of the yellow wavelength band;
said light source device is further provided with a separation unit that includes: a green light transmission area that transmits, from light of the said yellow wavelength band, only light of a green wavelength band; and a red light transmission area that transmits, from light of said yellow wavelength band, only light of a red wavelength band; and
said separation unit is provided such that light of said yellow wavelength band emitted from said fluorescent unit is successively irradiated upon said green light transmission area and said red light transmission area.

8. The light source device as set forth in claim 7, wherein said separation unit further includes a diffusion area that diffuses light of said first wavelength that is emitted by said second optical element.

9. A projection-type display device comprising:
the light source device as set forth in claim 1; and
a display panel that uses light emitted from said light source device to form an image.
